(19) United States
(12) Patent Application Publication
(10) Pub. No.: US 2026/0241392 A1
(43) Pub. Date: Aug. 20, 2026

(54) COMPOSITIONS FOR LITHIUM BENEFICIATION AND METHODS OF USE

(71) Applicant: Ecolab USA Inc., St. Paul, MN (US)

(72) Inventors: Yu Xiong, Charlotte, NC (US); Timothy La, Kardinya (AU); Rafaela Fernanda Carvalhal Passos, Valinhos (BR); Ryan Travis Chester, Connolly (AU)

(21) Appl. No.: 19/536,459

(22) Filed: Feb. 11, 2026

Related U.S. Application Data
(60) Provisional application No. 63/758,488, filed on Feb. 14, 2025.

(51) Int. Cl. B03D 1/008; H01M 4/38; H01M 4/485; H01M 4/58; H01M 4/62; H01M 10/0525

(52) U.S. Cl. CPC B03D 1/008; H01M 4/382; H01M 4/485; H01M 4/5825; H01M 4/622; H01M 10/0525

(57) ABSTRACT

Methods suitable for purification of lithium ore sources such as spodumene-bearing pegmatite, petalite, Zinnwaldite, Jadarite, or lithium mica include combining a lithium ore source, a water source, a collector composition, and optionally a frothing agent to form a lithium beneficiation slurry; sparging the lithium beneficiation slurry; separating the sparged lithium beneficiation slurry to form a lithium beneficiary and a gangue; and collecting the lithium beneficiary, where the collector composition includes a fatty acid source, a sulfonated fatty acid source, and a fatty acid adduct of succinic anhydride. The collectors obtain improved performance in terms of reduced organic content, increased lithium content and decreased iron content. Additionally, in some cases the collectors obtain the ability to exclude addition of a separate frothing agent during the beneficiation.

### BACKGROUND

Lithium metal has many industrial applications including rechargeable batteries, ceramics, aluminum alloys, pharmaceuticals, polymers, specialty glass, high-temperature grease, and casting flux. One of the primary applications of high-purity lithium is lithium-ion batteries. Lithium-ion batteries have a much higher charge-to-weight ratio and power-to-weight ratio than lead/acid and zinc carbon cells, and the development of lithium-ion battery technology has caused a global increase in the demand for lithium as a battery metal. The popularity of small electronic devices employing lithium-ion batteries was an initial driver of an increased demand, while the more recent adoption of rechargeable batteries to power vehicles has caused a large increase in the demand for high-purity lithium metal.

Lithium-bearing mineral ores such as spodumene ores and lithium micas are commercially employed as sources of high-purity lithium metal. Spodumene is a pyroxene mineral having the chemical composition LiAlSi₂O₆ (with minor amounts of Na substituted for Li in some cases). Lepidolite, a lithium-rich mica (basic potassium lithium aluminum fluorosilicate), is another industrially useful source of lithium metal. Commercially, lithium-bearing ores may be subjected to one or more processes to liberate, collect, and/or purify lithium species, that is, to separate the lithium-bearing mineral—such as spodumene—from the surrounding impurities and rock matrix materials such as quartz, feldspar, and the like commonly associated with mineral ore sources. These separation processes exploit the differences in physical and chemical properties between ore components. Often the term “differentiability” is applied to mineral separation processes to indicate the one or more properties that can by exploited to differentiate the mineral of interest from the gangue material, in order to enable their separation.

Industrially, a commonly used process to separate lithium mineral products from lithium ores is a beneficiation process that includes comminution, alkaline scrubbing, fatty acid conditioning, and flotation of the ore to separate the lithium mineral product beneficiary from the remaining rock materials.

Two common forms of froth flotation separation processes are direct flotation and reverse flotation. In direct flotation of lithium ores, flotation is obtained by sparging a slurry of comminuted, scrubbed, and conditioned lithium ore in an aqueous medium that is typically 30% ore solids by weight or more, for example 50 wt % ore solids or more. The lithium ore slurry is sparged and/or mechanically agitated to produce bubbles throughout, and the bubbles form a froth on the surface of the slurry that is enriched in the desired lithium mineral product, termed the beneficiary or concentrate. Since the froth is collected from the surface in a direct froth flotation process, the froth is often termed the overflow. The underflow, that is, the portion of slurry that remains after the froth is collected in a direct froth flotation process, is depleted in the lithium mineral product. The underflow in a direct froth flotation process is termed the gangue or tailings. The collected froth is subjected to further processing, such as concentration or dewatering, and/or further purification. Industrially, two or more cycles of lithium ore sparging and collection may be carried out prior to further processing using a flotation circuit, such as a rougher-scavenger type circuit, in order to maximize yield and/or purity of the lithium mineral product (beneficiary) ultimately collected for further processing.

In direct flotation processes such as those detailed above, the froth comprises the beneficiary, while in reverse flotation processes the overflow (froth) comprises the gangue and the underflow comprises the beneficiary. The object of both types of froth flotation is to separate and recover as much as possible of the beneficiary from the particulate material as possible.

In most cases, a frothing agent is added to a lithium ore slurry to adjust the tendency of the slurry to form bubbles of desirable size and rise velocity as well as provide a stable froth (where most of the bubbles collected as a froth at the surface of the slurry do not rupture during the flotation and collection thereof). Common frothing agents include natural plant oils, C5-C7 alkanols, polyglycols and alkoxy substituted adducts thereof; and alkoxy substituted hydrocarbons. Additionally, a collector is often added to the lithium ore slurry to further increase the tendency of the lithium mineral product to associate with the surface of the bubbles. Common collectors for lithium mineral products include anionic and/or cationic surfactants.

While froth flotation is recognized as an effective method for increasing purity and yield of lithium mineral product overall, the lithium ore purification industry presently suffers from a paucity of technologies for effective separation of organic compounds from the lithium mineral product during the lithium ore flotation process. Organic compounds—that is, compounds having at least one carbon atom—that are present within mineral ores as excavated from the earth are termed “native” organic compounds herein. Other organic compounds are added to the ore during one or more beneficiation processes or other mineral processing stages, and the organic compounds added to a lithium ore slurry in order to obtain froth flotation separation can remain associated with the lithium beneficiary collected therefrom. Thus, organic compounds that are collectors and frothing agents, for example, and any other organic compounds added to a lithium ore or a slurry thereof can remain associated with a lithium beneficiary, reducing productivity (yield) of the flotation circuit and the purity of the lithium mineral product collected. Additionally, in some cases one or more organic compounds that remain associated with a collected lithium mineral product can cause side reactions or other undesirable effects in subsequent processing steps, and additional purification must be carried out in order to produce a sufficiently pure lithium mineral product for its intended use.

Accordingly, there is an ongoing and increasing need to lower the concentration of organic compounds present in lithium mineral products collected from froth flotation processes. There is an ongoing need in the industry to increase the efficiency and yield of froth flotation of lithium ores. There is an ongoing need in the industry to increase the yield of lithium mineral product obtained from lithium ore sources. These needs should be addressed using apparatuses and equipment already in use in the lithium ore processing industry, in order to avoid undue complication and cost to operators wishing to obtain the benefits of reduced concentration of organic compounds in lithium mineral products collected from a froth flotation process.

The foregoing needs are addressed by the compositions and methods described herein.

### SUMMARY

Disclosed in first embodiments herein are Fatty Mixtures, which are actives in one or more collector compositions for froth flotation of a lithium ore. The Fatty Mixtures comprise, consist essentially of, or consist of a mixture of a fatty acid source, a sulfonated fatty acid source, and a fatty adduct of succinic anhydride, where fatty groups include at least 12 carbons. In some first embodiments, the ratio of the fatty acid source to the sulfonated fatty acid source in the Fatty Mixture is about 20:1 to about 1:1 by weight. In some first embodiments, the ratio of the fatty acid source to the fatty adduct of succinic anhydride in the Fatty Mixture is about 50:1 to about 5:1 by weight. In some first embodiments, the ratio of the sulfonated fatty acid source to the fatty adduct of succinic anhydride in the fatty mixture is about 10:1 to about 1:1 by weight.

Also disclosed in second embodiments herein are collector composition comprising, consisting essentially of, or consisting of a Fatty Mixture of first embodiments, combined with a surfactant and a solvent. In some second embodiments, the surfactant is a nonionic surfactant having an HLB between 2 and 20. In some second embodiments, the surfactant is present in the collector composition in an amount of 0.1 parts by weight to 20 parts by weight. In some second embodiments, the solvent is a water-miscible solvent is selected from glycols, alkanols, and any mixtures thereof that have a liquid phase over at least a portion of the temperature range between 0° C. and 100° C., and are miscible with liquid water at any concentration between 0% and 100% at least at one temperature within the range 0° C. to 100° C. In some second embodiments the solvent is present in the collector composition in an amount of 0.1 parts by weight to 30 parts by weight.

Also disclosed in third embodiments herein are lithium beneficiation slurries comprising, consisting essentially of, or consisting of a collector composition of second embodiments combined with a lithium ore source, a water source, and optionally a pH adjustment agent. In some third embodiments, the lithium beneficiation slurry further comprises a frothing agent; in other third embodiments, the lithium beneficiation slurry excludes a frothing agent. In some third embodiments, the collector composition is present in the lithium beneficiation slurry in an amount of 1 g/t to 10,000 g/t based on the weight of the lithium ore source. In some third embodiments, the Fatty Mixture of first embodiments is present in the lithium beneficiation slurry in an amount of 1 g/t to 10,000 g/t based on the weight of the lithium ore source. In some third embodiments, the pH of the lithium beneficiation slurry is between 7.0 and 11.5.

Also disclosed in fourth embodiments herein are methods of froth flotation comprising steps (I) or steps (II):
(I) combining a lithium ore source and a water source to form a lithium ore slurry,
   applying a collector composition of second embodiments to the lithium ore slurry to form a lithium beneficiation slurry,
   sparging the lithium beneficiation slurry, and
   collecting a lithium beneficiary from the sparged lithium beneficiation slurry;
(II) combining a collector composition of second embodiments with a lithium ore source to form a conditioning slurry;
   applying a water source to the conditioning slurry to form a lithium beneficiation slurry;
   sparging the lithium beneficiation slurry; and
   collecting a lithium beneficiary from the sparged lithium beneficiation slurry.

In some fourth embodiments, the methods further include adding a pH adjustment agent to the lithium ore slurry or to the lithium beneficiation slurry, in an amount sufficient to obtain a lithium beneficiation slurry pH of 7.0-11.5. In some fourth embodiments, the methods further include adding a frothing agent to the lithium ore slurry, to the lithium beneficiation slurry, or to the conditioning slurry. In other fourth embodiments, the methods exclude adding a frothing agent to the lithium ore slurry, to the lithium beneficiation slurry, or to the conditioning slurry. In some fourth embodiments, the methods are carried out in a flotation circuit.

Also disclosed in fifth embodiments herein are uses of the Fatty Mixtures of first embodiments and the collector compositions of second embodiments for obtaining reduced total organic carbon (TOC), reduced iron (Fe₂O₃), and/or increased lithium (Li₂O) content in lithium beneficiaries. Also disclosed in fifth embodiments herein are uses of the Fatty Mixtures of first embodiments and the collector compositions of second embodiments in kits for obtaining reduced total organic carbon (TOC), reduced iron (Fe₂O₃), and/or increased lithium (Li₂O) content in lithium beneficiaries.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

All patents, patent applications (including provisional applications), and publications cited herein are individually incorporated herein by reference for all purposes. Unless otherwise indicated, all parts and percentages are by weight. Unless otherwise indicated, all molecular weights are weight average molecular weights.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of’ and “consisting essentially of,” the embodiments or elements presented herein, whether explicitly set forth or not.

As used herein, the term “optional” or “optionally” means that an event or circumstance may but need not occur, or exist, or arise; and includes instances where the event or circumstance occurs, exists, or arises and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5” and “about 1 to about 5” and “1 to about 5” and “about 1 to 5” unless specifically limited by context.

As used herein, “substantially” means “consisting essentially of”, as that term is construed in U.S. patent law, and includes “consisting of” as that term is construed in U.S. patent law. For example, a solution that is “substantially free” of a specified compound or material may be free of that compound or material, or may have a minor amount of that compound or material present, such as through unintended contamination, side reactions, or incomplete purification. A “minor amount” may be a trace, an unmeasurable amount, an amount that does not interfere with a value or property, or some other amount as provided in context. A composition that has “substantially only” a provided list of components may consist of only those components, or have a trace amount of some other component present, or have one or more additional components that do not materially affect the properties of the composition. Additionally, “substantially” modifying, for example, the type or quantity of an ingredient in a composition, a property, a measurable quantity, a method, a value, or a range, employed in describing the embodiments of the disclosure, refers to a variation that does not affect the overall recited composition, property, quantity, method, value, or range thereof in a manner that negates an intended composition, property, quantity, method, value, or range. Where modified by the term “substantially” the claims appended hereto include equivalents according to this definition.

As used herein, any recited ranges of values contemplate all values within the range and are to be construed as support for claims reciting any sub-ranges having endpoints which are real number values within the recited range. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

### First Embodiments

In first embodiments herein, a Fatty Mixture is disclosed. A Fatty Mixture of first embodiments comprises, consists essentially of, or consists of a mixture of a fatty acid source, a sulfonated fatty acid source, and a fatty adduct of succinic anhydride. The Fatty Mixture may be used in a collector composition in the froth flotation of a lithium ore, where it unexpectedly obtains superior results in reducing the total organic carbon (TOC) of the lithium beneficiary collected from the flotation, and additionally provides reduced iron content, calculated as % Fe₂O₃; and excellent yield of lithium, calculated as Li₂O. In some embodiments, the use of the Fatty Mixture in a collector composition obviates the need to use a separate frothing agent in the froth flotation in order to obtain the foregoing benefits, which is a significant and completely unexpected result.

Accordingly, in any one or more first embodiments herein, the fatty acid source of the Fatty Mixture consists essentially of or consists of a fatty acid and/or a conjugate base thereof, or any mixture thereof. As used herein, “fatty” refers herein to an aliphatic, linear or branched, saturated or unsaturated hydrocarbyl group having 12 or more carbons. In some first embodiments the fatty group has 12-50 carbons, or 12-40 carbons, or 12-30 carbons, or 12-20 carbons, or 14-50 carbons, or 14-40 carbons, or 14-30 carbons, or 14-28 carbons, or 14-26 carbons, or 14-24 carbons, or 14-22 carbons, or 16-50 carbons, or 16-40 carbons, or 16-30 carbons, or 16-28 carbons, or 16-26 carbons, or 16-24 carbons, or 16-22 carbons.

In any one or more embodiments herein, a fatty group is aliphatic. In any one or more embodiments herein, a fatty group is linear or branched. In any one or more embodiments herein, a fatty group is saturated, or monounsaturated, or polyunsaturated (two or more unsaturated sites). In any one or more embodiments herein, any one or more unsaturated sites of a fatty group are independently configured as cis or trans. In any one or more embodiments herein, where a fatty hydrocarbyl group is polyunsaturated, the unsaturated sites are conjugated or unconjugated.

In any one or more embodiments herein, a “fatty acid” is a compound that includes fatty group bonded to a carboxyl group, where the carboxyl group is a carboxylic acid group (—COOH) or a conjugate base thereof. In some embodiments, the conjugate base of a fatty acid further comprises a counterion comprising, consisting essentially of, or consisting of an alkali metal ion, an alkaline earth metal ion, ammonium, or an organic ammonium (such as an alkanolammonium, e.g. ethanolammonium, or an alkylammonium, e.g. tetramethylammonium or triethylammonium). In some such embodiments, the counterion is selected from sodium, ammonium, or alkanolammonium.

In any one or more first embodiments herein, the fatty acid source consists of, consists essentially of, or consists of a soy oil fatty acid (SOFA) and/or a conjugate base thereof; a tall oil fatty acid (TOFA) and/or a conjugate base thereof; oleic acid (OA) and/or a conjugate base thereof; a soapstock fatty acid (SS) and/or a conjugate base thereof; or any mixture of two or more of these. SOFA and TOFA can vary compositionally within characteristic ranges depending on the individual plants and their growing environment. Representative SOFA and TOFA compositions are shown in Table 1.

SS is a mixture of fatty acids derived as a byproduct of soybean oil refining and often having, on a weight basis, about 47-49% linoleic acid, about 24-26% oleic acid, about 14-15% palmitic acid, about 5-6% stearic acid, about 2-3% linolenic acid, about 1-2% trans-elaidic acid, 1% or less of eicosenoic acid, and 1% or less of heneicosanoic acid.

TABLE 1
Reported concentrations, by weight, of fatty acids in tall oil f
atty acid and soy oil fatty acid sources.

| | | Tall | Soy | Soy |
|---|---|---|---|---|
| | | Oil | Oil | Oil |
| | | fatty | fatty | fatty |
| | | acid | acid | acid |
| | | (TOFA), | (SOFA), | (SOFA), |
| | | % | % | % |
| Fatty Acid | | com- | com- | com- |
| Type | Fatty Acid | ponent¹ | ponent² | ponent³ |
| C16 | palmitic | 1 | 12.2 | 9-13 |
| saturated | acid | | | |
| C18 | stearic | 2 | 3.8 | 2.5-5 |
| saturated | acid | | | |
| C18 | oleic acid | 48 | 21.5 | 17-30 |
| monoun- | | | | |
| saturated | | | | |
| C18 | linoleic | 35 | 54.2 | 48-58 |
| diun- | acid (8,11- | | | |
| saturated | diun- | | | |
| | saturated) | | | |
| | conjugated | 7 | no info | no info |
| | diuns- | | | |
| | aturated | | | |
| | [various] | | | |
| C18 | linolenic | <4% | 8.3 | 4-11 |
| triun- | acid | | | |
| saturated | | | | |

¹Kiran, S. et al., The HLD Study of Surfactant Partitioning for Oilfield Corrosion Inhibitors” Table 2; published at https://www.research.net/figure/Composition-of-a-Typical-Tall-Oil-Fatty-Acid_tbl1_270961333
²Abdelghany, A. et al., The Crop Journal Volume 8, Issue 4, August 2020, Pages 635-644
³NIH Natl. Library of Medicine, National Center for Biotechnology Information, Compound Summary for Soybean Oil, SID 481190644; https://pubchem.ncbi.nlm.nih.gov/compound/Soybean-Oil

In some first embodiments herein, the fatty acid source comprises, consists essentially of, or consists of an admixture of SOFA with TOFA in a weight ratio of about 20:1 to about 1:20 SOFA:TOFA, for example about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, about 1:11, about 1:12, about 1:13, about 1:14, about 1:15, about 1:16, about 1:17, about 1:18, about 1:19, or about 1:20 SOFA:TOFA by weight.

In some first embodiments herein, the fatty acid source comprises, consists essentially of, or consists of an admixture of SOFA with OA in a weight ratio of about 20:1 to about 1:20 SOFA:OA, for example about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, about 1:11, about 1:12, about 1:13, about 1:14, about 1:15, about 1:16, about 1:17, about 1:18, about 1:19, or about 1:20 SOFA:OA by weight.

In some first embodiments herein, the fatty acid source comprises, consists essentially of, or consists of an admixture of TOFA, OA, and SOFA in a weight ratio of about 20:1:1 to about 1:20:1 to about 1:1:20 TOFA:OA:SOFA.

In some first embodiments herein, the fatty acid source comprises, consists essentially of, or consists of an admixture of SS with one or a combination of two or more of SOFA, TOFA, and/or OA in a weight ratio of about 20:1 to about 1:20 SS:[SOFA and/or TOFA and/or OA].

In any one or more first embodiments herein, the fatty acid source is a Mixture (A) of fatty acids, wherein Mixture (A) has a chemical makeup that is, by weight:
A1. more than 1% palmitic acid and/or a conjugate base thereof, or
A2. more than 2% stearic acid and/or a conjugate base thereof, or
A3. less than 48% oleic acid and/or a conjugate base thereof, or
A4. more than 35% linoleic acid and/or a conjugate base thereof, or
A5. about 4% or more linolenic acid and/or a conjugate base thereof, or
A6. any combination of two or more of A1, A2, A3, A4, and A5.

In any one or more first embodiments herein, the fatty acid source is a Mixture (B) of fatty acids, wherein Mixture (B) has a chemical makeup that is, by weight:
B1. more than 1% and up to about 13% palmitic acid and/or a conjugate base thereof, such as 1.5%-2%, or 2%-3%, or 3%-4%, or 4%-5%, or 5%-6%, or 6%-7%, or 7%-8%, or 8%-9%, or 9%-10%, or 10%-11%, or 11%-12%, or 12%-13% palmitic acid and/or a conjugate base thereof, or
B2. more than 2% and up to about 5% stearic acid and/or a conjugate base thereof, such as 2.5%-30.0%, or 3.0%-30.5%, or 3.5%-4.0%, or 4.0%-40.5%, or 4.5%-5.0% stearic acid and/or a conjugate base thereof, or
B3. less than 48% and as low as about 17% oleic acid and/or a conjugate base thereof, such as 17%-19%, or 19%-21%, or 21%-23%, or 23%-25%, or 25%-27%, or 27%-29%, or 29%-31%, or 31%-33%, or 33%-35%, or 35%-37%, or 37%-39%, or 39%-41%, or 41%-43%, or 43%-45%, or 45%-47%, or 47%-48% oleic acid and/or a conjugate base thereof, or
B4. more than 35% and up to about 58% linoleic acid and/or a conjugate base thereof, such as 36%-38%, or 38%-40%, or 40%-42%, or 42%-44%, or 44%-46%, or 46%-48%, or 48%-50%, or 50%-52%, or 52%-54%, or 54%-56%, or 56%-58% % linoleic acid and/or a conjugate base thereof, or
B5. about 4% to about 11% linolenic acid and/or a conjugate base thereof, such as 4%-5%, or 5%-6%, or 6%-7%, or 7%-8%, or 8%-9%, or 9%-10%, or 10%-11% linolenic acid and/or a conjugate base thereof,
B6. any combination of two or more of B1, B2, B3, B4, and B5; or
B7. any combination of one or more of B1, B2, B3, B4, or B5 with one or more of A1, A2, A3, A4, or A5.

In some first embodiments herein, the fatty acid source is an admixture of SOFA with SOFA, and/or TOFA, and/or OA, and/or SS, and/or another fatty acid or fatty acid mixture, wherein the admixture is a Mixture (A) fatty acid source or a Mixture (B) fatty acid source. In some such embodiments, SOFA is present in the admixture in an amount of about 10% to about 99% by weight of the fatty acid source, for example 10%-15%, 15%-20%, 20%-25%, 25%-30%, 30%-35%, 35%-40%, 40%-45%, 45%-50%, 50%-55%, 55%-60%, 60%-65%, 65%-70%, 70%-75%, 75%-80%, 80%-85%, 85%-90%, 90%-95%, or 95%-99% by weight of the fatty acid source, further wherein the fatty acid source is a Mixture (A) fatty acid source or a Mixture (B) fatty acid source.

As noted above, the Fatty Mixture of first embodiments includes a sulfonated fatty acid source. In any one or more first embodiments herein, the sulfonated fatty acid source consists of, consists essentially of, or consists of a sulfonated SOFA, a sulfonated TOFA, a sulfonated OA, a sulfonated SS, or any mixture or two or more of these. In some first embodiments, the sulfonated fatty acid source is sulfonated TOFA or sulfonated oleic acid.

Industrially, the sulfonated fatty acid source is most often synthesized by the continuous sulfonation of the corresponding fatty acid with gaseous sulfur trioxide, followed by neutralization and hydrolysis of the acidic sulfonation product with an aqueous metal hydroxide, such as sodium hydroxide or potassium hydroxide, to yield a sulfonated fatty acid product that is useful as the sulfonated fatty acid source of the Fatty Mixture. The sulfonated fatty acid source includes a characteristic ratio of sulfonated to non-sulfonated fatty acids, consistent with the yield of the sulfonation reaction. Accordingly, in any one or more first embodiments, the ratio of sulfonated to non-sulfonated fatty acids in the sulfonated fatty acid source is between 3:1 and 5:1 by weight, often about 4:1 by weight.

The sulfonated fatty acid source further includes water added and/or generated during the neutralization and hydrolysis of the acidic sulfonation product. In any one or more first embodiments, the amount of water in the sulfonated fatty acid source is about 20-30% by weight, often about 25% by weight of the sulfonated fatty acid source.

In any one or more first embodiments, the unsulfonated (unreacted) fatty acids present in the sulfonated fatty acid source are fatty acids as defined above, and thereby contribute to the total fatty acid concentration present in the Fatty Mixture.

In any one or more first embodiments herein, the ratio of the fatty acid source to the sulfonated fatty acid source in the Fatty Mixture is about 20:1 to about 1:1 by weight, such as about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, about 2:1, or about 1:1 by weight. In any one or more first embodiments herein, the ratio of the fatty acid source to the sulfonated tall oil fatty acid source is about 5:1 to about 3:1 by weight.

Also as noted above, the Fatty Mixture of first embodiments includes a fatty adduct of succinic anhydride (FSA). FSAs are derivatives of succinic anhydride wherein one H of the succinic anhydride ring is replaced with a fatty group. FSAs are suitably represented by formula I,

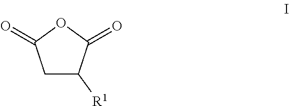

wherein R¹ is an aliphatic, linear or branched hydrocarbyl group having 12-50 carbons, or 12-40 carbons, or 12-30 carbons, or 12-20 carbons, or 14-50 carbons, or 16-50 carbons, or 14-30 carbons, or 16-30 carbons, or 14-28 carbons, or 14-26 carbons, or 14-24 carbons, or 14-22 carbons, or 16-28 carbons, or 16-26 carbons, or 16-24 carbons, or 16-22 carbons; further wherein R¹ is saturated, monounsaturated, or polyunsaturated, further wherein any one or more unsaturated sites are independently configured as cis or trans; and further where R¹ is polyunsaturated, the unsaturated sites are conjugated or unconjugated. The FSA suitably comprises a single compound or mixture of two or more FSA species, each of which has a structure corresponding to formula I and varies by structure of R¹; in any embodiment herein, reference to FSA in singular or plural refers to single FSA species and any mixture thereof.

In any one or more first embodiments herein, the FSA comprises, consists essentially of, or consists of an alkenyl succinic anhydride (ASA), wherein R¹ of formula I is a linear or branched monounsaturated C12-C50 hydrocarbon (alkene), often a C14-C30 alkene. ASAs are prepared by the Alder-ene reaction of alkenes with maleic anhydride at temperatures in excess of 200° C. In any one or more first embodiments herein, R¹ is branched hexadecenyl, branched octadecenyl, or a mixture thereof. In any one or more first embodiments herein, the ASA comprises, consists essentially of, or consists of iso-octadecenylsuccinic anhydride (“C₁₈-ASA”) or a mixture of C₁₈-ASA with one or more other ASAs.

In any one or more first embodiments herein, the Fatty Mixture is suitably formed by admixing the fatty acid source, the sulfonated fatty acid source, and the FSA in any order. The admixing is suitably carried out using conventional equipment for mixing liquids, in particular viscous liquids.

In any one or more first embodiments herein, the fatty acid source is present in the Fatty Mixture in an amount that is 50% to 90% by weight of the Fatty Mixture, for example 50% to 55%, 55% to 60%, 60% to 65%, 65% to 70%, 70% to 75%, 75% to 80%, 80% to 85%, 85% to 90%, about 50%, about 55%, about 60%, about 65%, about 70%, about 75%, about 80%, about 85%, or about 90% by weight of the Fatty Mixture. In any one or more first embodiments herein, the sulfonated fatty acid source is present in the Fatty Mixture in an amount that is 1% to 45% by weight of the Fatty Mixture, for example 1% to 3%, 3% to 5%, 5% to 7%, 7% to 10%, 10% to 12%, 12% to 15%, 15% to 17%, 17% to 20%, 20% to 22%, 22% to 25%, 25% to 27%, 27% to 30%, 30% to 35%, 35% to 40%, 40% to 45%, about 10%, about 12%, about 14%, about 16%, about 18%, about 20%, about 22%, about 24%, about 26%, about 28%, about 30%, about 35%, about 40%, or about 45% by weight of the Fatty Mixture.

In any one or more first embodiments herein, water is present in the Fatty Mixture in an amount that is about 1% to about 20% by weight of the Fatty Mixture, for example 1% to 2%, 2% to 3%, 3% to 4%, 4% to 5%, 5% to 6%, 6% to 7%, 7% to 8%, 8% to 9%, 9% to 10%, 10% to 11%, 11% to 12%, 12% to 13%, 13% to 14%, 14% to 15%, 15% to 16%, 16% to 17%, 17% to 18%, 18% to 19%, 19% to 20%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight of the Fatty Mixture.

In any one or more first embodiments herein, the FSA is present in the Fatty Mixture in an amount that is about 1% to about 20% by weight of the Fatty Mixture, for example 1% to 2%, 2% to 3%, 3% to 4%, 4% to 5%, 5% to 6%, 6% to 7%, 7% to 8%, 8% to 9%, 9% to 10%, 10% to 11%, 11% to 12%, 12% to 13%, 13% to 14%, 14% to 15%, 15% to 16%, 16% to 17%, 17% to 18%, 18% to 19%, 19% to 20% about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight of the Fatty Mixture.

As noted above, in any one or more first embodiments herein, the ratio of the fatty acid source to the sulfonated fatty acid source in the Fatty Mixture is about 20:1 to about 1:1 by weight, such as about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, about 2:1, or about 1:1 by weight. In any one or more first embodiments herein, the ratio of the fatty acid source to the sulfonated tall oil fatty acid source is about 5:1 to about 3:1 by weight.

In any one or more first embodiments herein, the ratio of the fatty acid source to the FSA is about 50:1 to about 5:1 by weight, such as about 50:1 to 45:1, or about 45:1 to 40:1, or about 40:1 to 35:1, or about 35:1 to 30:1, about 30:1 to 25:1, about 25:1 to 20:1, about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, or about 5:1 by weight. In any one or more first embodiments herein, the ratio of the fatty acid source to the FSA is about 20:1 to about 10:1 by weight.

In any one or more first embodiments herein, the ratio of the sulfonated fatty acid source to the FSA is about 10:1 to about 1:1 by weight, such as about 10:1, about 9:1, about 8:1, about 7:1, about 6:1, about 5:1, about 4:1, about 3:1, about 2:1, or about 1:1 by weight. In any one or more first embodiments herein, the ratio of the sulfonated fatty acid source to the FSA is about 5:1 to about 3:1 by weight.

In any one or more first embodiments herein, the ratio of the fatty acid source to the sulfonated fatty acid source to the fatty adduct of succinic anhydride is about 15:4:1 by weight, or about 16:4:1 by weight, or about 17:4:1 by weight, or about 14:4:1 by weight, or about 13:4:1 by weight, or about 15:5:1 by weight, or about 15:6:1 by weight, or about 15:3:1 by weight, or about 15:2:1 by weight.

As described in fifth embodiments below, the Fatty Mixture may be present within, or placed within in a container as part of a kit for obtaining froth flotation of a lithium ore. Alternatively, as described in second embodiments below, the Fatty Mixture is further combined with a surfactant and a solvent to form a collector composition. The collector compositions can also be present in a kit for obtaining froth flotation of a lithium ore, as noted in fifth embodiments below.

### Second Embodiments

In second embodiments herein, collector compositions are described. A collector composition of second embodiments comprises, consists essentially of, or consists of a Fatty Mixture of first embodiments herein, further combined with a surfactant and a solvent. The collector compositions are suitably admixed in any order of components: fatty acid source, sulfonated fatty acid source, FSA, solvent, and surfactant. The collector compositions are usefully added to a lithium ore slurry for froth flotation partitioning of a lithium mineral product from the ore. The surfactant and solvent components of the collector composition provide improved dispersion of the Fatty Mixture with a lithium ore or a lithium ore slurry, compared to addition of a Fatty Mixture to a lithium ore or lithium ore slurry in the absence of the surfactant and solvent.

The surfactant suitably comprises a single surfactant compound (species) or mixture of two or more surfactant species in any ratio. In any one or more second embodiments herein, the surfactant comprises, consists essentially of, or consists of a nonionic surfactant or mixture of two or more nonionic surfactants. In any one or more second embodiments herein, the nonionic surfactant, or mixture of surfactants overall has an HLB (hydrophilic-lipophilic balance) value between about 2 and about 20, such as 2-3, 3-4, 4-5, 5-6, 6-7, 7-8. 8-9. 9-10, 10-11, 11-12, 12-13, 13-14, 14-15, 15-16, 16-17, 17-18, 18-19, 19-20, about 2, about 3, about 4, about 5, about 6, about 7, about 8, about 9, about 10, about 11, about 12, about 13, about 14, about 15, about 16, about 17, about 18, about 19, about 20, between 2 and 20, between 3 and 12, or even between 3 and 10. HLB determined by calculating percentages of molecular weights for the hydrophilic and lipophilic portions of a surfactant molecule. Where the surfactant is a mixture of two or more surfactant species, the HLB of the surfactant mixture is obtained by calculating the HLB of each surfactant species, and providing a weighted average of the HLB values in accordance with the actual weight proportion of the surfactant species in the surfactant mixture.

In any one or more second embodiments herein, the surfactant comprises, consists essentially of, or consists of one of the surfactants listed in Table 2, and/or one or more a structurally similar surfactants; or any mixture thereof.

TABLE 2
Some nonionic surfactants useful in the collector
compositions of second embodiments, and
their reported HLB values.

| Surfactant | HLB |
|---|---|
| Sorbitan tristearate | 2.1 |
| Propylene glycol monostearate | 3.4 |
| Glycerol monostearate | 3.8 |
| Sorbitan monooleate | 4.3 |
| Sorbitan monostearate | 4.7 |
| Diethylene glycol monolaurate | 6.1 |
| Sorbitan monolaurate | 8.6 |
| Glycerol monostearate | 11 |
| Polyoxyethylene(2) cetyl ether | 5.3 |
| Polyoxyethylene(10) cetyl ether | 12.9 |
| Polyoxyethylene(2) cetyl ether | 15.7 |
| Polyoxyethylene(6) tridecyl ether | 11.4 |
| Polyoxyethylene(12) tridecyl ether | 14.5 |
| Polyoxyethylene sorbitan monooleate | 15 |

In some second embodiments, the nonionic surfactant is an alkoxylated sorbitan ester of a fatty acid or a mixture of alkoxylated sorbitan esters having formula II,

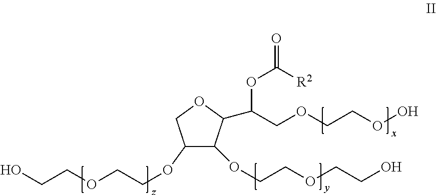

wherein R² is a fatty group, that is, an aliphatic, linear or branched hydrocarbyl group having 12-50 carbons, that is saturated, monounsaturated, or polyunsaturated, further wherein any one or more unsaturated sites are independently configured as cis or trans, and further wherein if the fatty group is polyunsaturated, the unsaturated sites are conjugated or unconjugated. In some second embodiments herein, R² is hexadecyl, heptadecyl, octadecyl, hexadecenyl, heptadecenyl, octadecenyl, or a mixture thereof. In some second embodiments herein, R² is heptadecenyl, which is provided by esterifying 9-octadecenoic acid (oleic acid) with sorbitan.

In any one or more second embodiments herein, the alkoxylated sorbitan fatty acid ester further includes a total of 1-1000 alkoxy repeat units bonded thereto, for example 3-5, 5-7, 7-10, 10-12, 12-15, 15-17, 17-20, 20-30, 30-40, 40-50, 50-60, 60-70, 70-80, 80-90, 90-100, 100-200, 200-300, 300-400, 400-500, 500-600, 600-700, 700-800, 800-900, or 900-1000 alkoxy repeat units bonded thereto. The alkoxy repeat units are independently ethoxy or propoxy repeat units bonded to 1, 2, or all 3 available hydroxyl moieties of sorbitol. In formula II, all the alkoxylate repeat units are ethoxylate repeat units. Further in formula II, the sum of x+y+z is between 1 and 1000, such as 3-5, 5-7, 7-10, 10-12, 12-15, 15-17, 17-20, 20-30, 30-40, 40-50, 50-60, 60-70, 70-80, 80-90, 90-100, 100-200, 200-300, 300-400, 400-500, 500-600, 600-700, 700-800, 800-900, or 900-1000; and often 3-400, 3-200, 10-200, 3-100, or 10-100. In any one or more second embodiments herein, the alkoxylated sorbitan ester comprises, consists essentially of, or consists of an ethoxylated sorbitan monooleate (polyoxyethylene sorbitan monooleate).

In any one or more second embodiments herein, the solvent present in the collector composition comprises, consists essentially of, or consists of a water miscible solvent or mixture of two or more water miscible solvents. Water is present in the Fatty Mixtures of first embodiments and therefore also in the collector compositions of second embodiments, as noted above, due to the presence of water in the sulfonated fatty acid source. The addition of a solvent to the collector composition is beneficial for obtaining good dispersion of the Fatty Mixture in a lithium ore slurry, which in turn is beneficial for effective froth flotation partitioning of the lithium ore present in the slurry.

In any one or more second embodiments herein, the water-miscible solvent is selected from glycols, alkanols, and any mixtures thereof that have a liquid phase over at least a portion of the temperature range between 0° C. and 100° C., and are miscible with liquid water at any concentration between 0% and 100% at least at one temperature within the range 0° C. to 100° C. In some second embodiments herein, useful solvents include C1-C6 alkanols, or C2-C5 alkanols, or C2-C4 alkanols; and C1-C4 glycols, or C2-C3 glycols; and any mixture of these. For example, useful alkanols include ethanol, n-propanol, and iso-butanol; and useful glycols include ethylene glycol, propylene glycol, and diethylene glycol. In some second embodiments herein, the solvent comprises a mixture of two or more alkanols, a mixture of two or more glycols, and/or a mixture of any one or more C1-C6 alkanols with any one or more of the foregoing C1-C4 glycols.

In any one or more second embodiments herein, the Fatty Mixture is present in the collector composition in an amount of about 50% to about 98% by weight of the collector composition, such as 50%-55%, 55%-60%, 60%-65%, 65%-70%, 70%-75%, 75-80%, 80%-85%, 85%-90%, 90%-95%, or 95%-98%, 80%-90%, or 85%-95% by weight of the collector composition.

In any one or more second embodiments herein, the nonionic surfactant is present in the collector composition in an amount of 0.1% to 20% by weight of the collector composition, such as 0.1%-1%, 1%-2%, 2%-3%, 3%-4%, 4%-5%, 5%-6%, 6%-7%, 7%-8%, 8%-9%, 9%-10%, 10%-11%, 11%-12%, 12%-13%, 13%-14%, 14%-15%, 15%-16%, 16%-17%, 17%-18%, 18%-19%, or 19%-20% by weight of the collector composition.

In any one or more second embodiments herein, the solvent is present in the collector composition in an amount of 0.1% to 30% by weight of the collector composition, such as 0.1%-1%, 1%-2%, 2%-3%, 3%-4%, 4%-5%, 5%-6%, 6%-7%, 7%-8%, 8%-9%, 9%-10%, 10%-11%, 11%-12%, 12%-13%, 13%-14%, 14%-15%, 15%-16%, 16%-17%, 17%-18%, 18%-19%, 19%-20%, 20%-21%, 21%-22%, 22%-23%, 23%-24%, 24%-25%, a 25%-26%, 26%-27%, 27%-28%, 28%-29%, or 29%-30% by weight of the collector composition.

In any one or more second embodiments herein, the fatty acid source is present in the collector composition in an amount that is 50% to 80% by weight of the Fatty Mixture, for example 50% to 55%, 55% to 60%, 60% to 65%, 65% to 70%, 70% to 75%, 75% to 80%, about 50%, about 55%, about 60%, about 65%, about 70%, about 75%, or about 80% by weight of the collector composition.

In any one or more second embodiments herein, the sulfonated fatty acid source is present in the collector composition in an amount that is 1% to 45% by weight of the collector composition, for example 1% to 3%, 3% to 5%, 5% to 7%, 7% to 10%, 10% to 12%, 12% to 15%, 15% to 17%, 17% to 20%, 20% to 22%, 22% to 25%, 25% to 27%, 27% to 30%, 30% to 35%, 35% to 40%, 40% to 45%, about 10%, about 12%, about 14%, about 16%, about 18%, about 20%, about 22%, about 24%, about 26%, about 28%, about 30%, about 35%, about 40%, or about 45% by weight of the collector composition.

In any one or more second embodiments herein, water is present in the collector composition, since it is a component of the sulfonated fatty acid source. In any one or more second embodiments herein, water is present in the collector composition in an amount that is about 1% to about 20% by weight of the collector composition, for example 1% to 2%, 2% to 3%, 3% to 4%, 4% to 5%, 5% to 6%, 6% to 7%, 7% to 8%, 8% to 9%, 9% to 10%, 10% to 11%, 11% to 12%, 12% to 13%, 13% to 14%, 14% to 15%, 15% to 16%, 16% to 17%, 17% to 18%, 18% to 19%, 19% to 20%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight of the collector composition.

In any one or more second embodiments herein, the FSA is present in the collector composition in an amount that is about 1% to about 20% by weight of the collector composition, for example 1% to 2%, 2% to 3%, 3% to 4%, 4% to 5%, 5% to 6%, 6% to 7%, 7% to 8%, 8% to 9%, 9% to 10%, 10% to 11%, 11% to 12%, 12% to 13%, 13% to 14%, 14% to 15%, 15% to 16%, 16% to 17%, 17% to 18%, 18% to 19%, 19% to 20% about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight of the collector composition.

In some second embodiments, a representative collector composition comprises, consists essentially of, or consists of:
about 50 parts to about 80 parts by weight of a fatty acid source;
about 1 part to about 45 parts by weight of a sulfonated fatty acid source; about 0.1 parts to about 20 parts by weight of an FSA;
about 0.1 parts to about 20 parts by weight of a nonionic surfactant; and about 0.1 parts to about 30 parts by weight of a solvent.

### Third Embodiments

In third embodiments herein, lithium beneficiation slurries are disclosed. In any one or more third embodiments herein, a lithium beneficiation slurry comprises, consists essentially of, or consists of a combination of any one of the collector compositions of second embodiments with a lithium ore source or a lithium ore slurry.

As used herein, “lithium ore”, “lithium ore source” and like terms refer to solid rock materials mined from one or more subterranean excavations, wherein the ore contains at least 10% by weight of a lithium-containing compound, for example about 10 wt % to 50 wt % of a lithium-containing compound. In embodiments the lithium ore source is a comminuted lithium ore, which is the as-mined lithium ore after one or more comminution processes such as crushing, milling and/or grinding. In embodiments the lithium ore is a “classified lithium ore”, which is a comminuted lithium ore that is further separated according to particle size, such as by a screening process, further wherein the classification is conducted substantially in the absence of a liquid.

As used herein, the term “beneficiation” refers to the processing of an ore slurry by froth flotation to obtain a mineral beneficiary therefrom. Lithium beneficiation includes separating a lithium mineral product (“beneficiary”, or “lithium beneficiary”) from the remaining ore materials (“gangue”) by forming an aqueous slurry thereof, sparging the slurry with a gas such as air, causing the lithium-containing mineral to associate with bubbles in the slurry, wherein the bubbles subsequently rise and collect on the surface of the slurry to form a froth that is enriched in the lithium beneficiary; and collecting the froth from the sparged slurry. The lithium beneficiary is enriched in a lithium mineral product when compared to the lithium ore as well as the gangue.

In any one or more third embodiments herein, a lithium ore source comprises, consists essentially of, or consists of a spodumene-bearing pegmatite, a petalite, a Zinnwaldite, a Jadarite, or a lithium mica. The lithium ore source is a solid material mined from one or more subterranean excavations and containing at least 0.1% by weight of a lithium-bearing compound or mineral, such as spodumene, calculated as wt % Li₂O: stated differently, a suitable lithium ore source has a “lithium potential” of at least 0.1% lithium as Li₂O. In any one or more third embodiments herein, the lithium ore source has a lithium potential between 0.1% and 10% lithium as Li₂O, for example 0.5% to 8%, or 1% to 8%, or 1% to 6%, often between 1% and 4% lithium as Li₂O. In embodiments the lithium ore source further includes one or more of quartz, clay, feldspar, or another mineral having silicon, aluminum, iron, and/or magnesium content.

In any one or more third embodiments herein, the lithium ore source is an “as-mined” or “raw” lithium ore, which is the rock product produced by mining operations without further modification. In other embodiments, the lithium ore beneficiation methods herein further include comminuting the lithium ore source and/or classifying the lithium ore source prior to combining the lithium ore source with the water source, collector, and optional frothing agent components. In embodiments the lithium ore source is a comminuted lithium ore source, which is the as-mined lithium ore source after one or more comminution processes such as crushing, milling, grinding, or a combination thereof. In embodiments the lithium ore source ore is a classified lithium ore source, which is a lithium ore source that is separated according to particle size, such as by a screening process, further wherein the classification is conducted substantially in the absence of a liquid. In embodiments the lithium ore source ore is a comminuted, classified lithium ore source, wherein the lithium ore source is both comminuted and classified, either sequentially or in a continuous circuit to produce a lithium ore source having a suitable particle size for beneficiation.

In any one or more third embodiments herein, an average particle size of a classified lithium ore source is between about 150 mm and 0.1 μm, for example about 150 mm to 1 mm, or about 100 mm to 1 mm, or about 50 mm to 1 mm, or about 100 mm to 0.1 μm, or about 50 mm to 0.1 μm, or about 30 mm to 0.1 μm, or about 20 mm to 0.1 μm, or about 10 mm to 0.1 μm, or about 1 mm to 0.1 μm, or about 1 mm to 1 μm, or about 1 mm to 10 μm. In embodiments, the average particle size is average particle diameter by mass, or “D50” (also “d50”). Where not otherwise specified, the value of D50 particle size is determined by a screening classification method. Other methods may be used to determine an average particle size, including D50 particle size; such methods include for example light scattering methods or liquid-based size exclusion methods.

In some third embodiments herein, a lithium ore is comminuted, optionally classified, then combined with water to form a slurry or pulp, and the collector composition is combined with the slurry/pulp. In some third embodiments herein, a lithium ore source is combined with a water source to form a lithium ore slurry; and the collector composition is added to the lithium ore slurry to form a lithium beneficiation slurry. In other third embodiments here, a lithium ore source is combined with the collector composition to form a conditioning slurry; and water is then added to the conditioning slurry to form a lithium beneficiation slurry.

In any one or more third embodiments herein, a lithium beneficiation slurry includes about 10 wt % to 90 wt % of the lithium ore source, with the majority of the balance of the weight of the slurry being the water source. In embodiments, the lithium beneficiation slurry includes 20% solids by weight or more, for example 30 wt % lithium ore solids or more. In embodiments, a lithium beneficiation slurry includes 10 wt % to 90 wt %, 10 wt % to 80 wt %, 20 wt % to 80 wt %, 30 wt % to 80 wt %, 40 wt % to 80 wt %, 20 wt % to 90 wt %, 30 wt % to 90 wt %, 40 wt % to 90 wt %, 50 wt % to 90 wt %, 60 wt % to 90 wt %, 10 wt % to 20 wt %, 10 wt % to 30 wt %, 20 wt % to 40 wt %, 30 wt % to 50 wt %, 40 wt % to 60 wt %, 50 wt % to 70 wt %, 60 wt % to 80 wt %, or 80 wt % to 90 wt % of the lithium ore source, wherein the balance of the lithium beneficiation slurry comprises, consists essentially of, or consists of the water source, collector composition, and optional frothing agent components.

In any one or more third embodiments herein, the water source of a lithium beneficiation slurry is water, tap water, fresh water, industrial wastewater from one or more mining operations, or another such source of water, which may further include up to 5 wt % total dissolved and/or suspended solids. In embodiments, the water source is a process water recovered from one or more industrial processes. In embodiments the industrial process is a lithium beneficiation process carried out in a froth flotation circuit, wherein water recovered from an initial lithium beneficiation slurry after separation of the lithium beneficiary therefrom is recycled and employed as the water source in a subsequent lithium beneficiation process.

In any one or more third embodiments herein, a lithium beneficiation slurry includes at least a lithium ore source, a water source, and a collector composition of second embodiments. These components are suitably combined in any order to form a lithium beneficiation slurry. In some third embodiments, a collector composition is added to a lithium ore slurry to form a lithium beneficiation slurry. In other embodiments, the collector composition and the water source are added contemporaneously to the lithium ore source to form a lithium beneficiation slurry. In still other embodiments, a lithium ore source is combined with the collector composition to form a conditioning slurry; and a water source is added to the conditioning slurry to form a lithium beneficiation slurry.

In any one or more third embodiments herein, the collector composition present in a lithium beneficiation slurry includes the Fatty Mixture of first embodiments herein, the components of which are active in the collection of lithium mineral product during froth flotation and therefore may be referred to herein as “collector composition actives”, or just “actives”. Accordingly, in any one or more third embodiments herein, a lithium beneficiation slurry includes about 1 g/t (grams per metric ton) to 10,000 g/t of collector composition actives—that is, the Fatty Mixture—based on the weight of the lithium ore source, for example 1 g/t to 9000 g/t, 1 g/t to 8000 g/t, 1 g/t to 7000 g/t, 1 g/t to 6000 g/t; or 1 g/t to 5000 g/t, 1 g/t to 4000 g/t, 1 g/t to 3000 g/t, 1 g/t to 2000 g/t, 1 g/t to 1000 g/t, 1 g/t to 900 g/t, 1 g/t to 800 g/t, 1 g/t to 700 g/t, 1 g/t to 600 g/t; 1 g/t to 500 g/t, 1 g/t to 400 g/t, 1 g/t to 300 g/t, 1 g/t to 200 g/t, 1 g/t to 100 g/t, 100 g/t to 200 g/t, 200 g/t to 300 g/t, 300 g/t to 400 g/t, 400 g/t to 500 g/t, 500 g/t to 600 g/t, 600 g/t to 700 g/t, 700 g/t to 800 g/t, 800 g/t to 900 g/t, 900 g/t to 1000 g/t, 1000 g/t to 2000 g/t, 2000 g/t to 3000 g/t, 3000 g/t to 4000 g/t, 4000 g/t to 5000 g/t, 5000 g/t to 6000 g/t, 6000 g/t to 7000 g/t, 7000 g/t to 8000 g/t, 8000 g/t to 9000 g/t, or 9000 g/t to 10,000 g/t of the collector composition actives—that is, the Fatty Mixture—based on the weight of the lithium ore. In some third embodiments, the collector composition is present in a lithium beneficiation slurry in an amount of about 400 g/t to 800 g/t of collector composition actives based on the weight of the lithium ore source.

In any one or more third embodiments herein, a lithium beneficiation slurry includes about 1 g/t (grams per metric ton) to 10,000 g/t of collector composition actives based on the weight of a lithium flotation feed, for example 1 g/t to 9000 g/t, 1 g/t to 8000 g/t, 1 g/t to 7000 g/t, 1 g/t to 6000 g/t; or 1 g/t to 5000 g/t, 1 g/t to 4000 g/t, 1 g/t to 3000 g/t, 1 g/t to 2000 g/t, 1 g/t to 1000 g/t, 1 g/t to 900 g/t, 1 g/t to 800 g/t, 1 g/t to 700 g/t, 1 g/t to 600 g/t; 1 g/t to 500 g/t, 1 g/t to 400 g/t, 1 g/t to 300 g/t, 1 g/t to 200 g/t, 1 g/t to 100 g/t, 100 g/t to 200 g/t, 200 g/t to 300 g/t, 300 g/t to 400 g/t, 400 g/t to 500 g/t, 500 g/t to 600 g/t, 600 g/t to 700 g/t, 700 g/t to 800 g/t, 800 g/t to 900 g/t, 900 g/t to 1000 g/t, 1000 g/t to 2000 g/t, 2000 g/t to 3000 g/t, 3000 g/t to 4000 g/t, 4000 g/t to 5000 g/t, 5000 g/t to 6000 g/t, 6000 g/t to 7000 g/t, 7000 g/t to 8000 g/t, 8000 g/t to 9000 g/t, or 9000 g/t to 10,000 g/t of the collector composition actives based on the weight of a lithium flotation feed. As defined herein, “flotation feed” means an ore source optionally mixed with one or more other materials. “Flotation feed” refers to materials that are added to a froth flotation cell for carrying out froth flotation. In any one or more third embodiments herein, the flotation feed is a lithium flotation feed, which is a flotation feed including a lithium ore source and optionally further including one or more of: water, surfactants, polymers, frothing agents, depressants, modifiers, pH adjustment agents, dispersants, stabilizers, and other processing additives and materials.

In any one or more third embodiments herein, a lithium beneficiation slurry excludes, or substantially excludes a frothing agent (frothing agent). In other embodiments, a frothing agent is optionally added to the lithium beneficiation slurry by adding it to the lithium ore source or to the lithium beneficiation slurry. Frothing agents include but are not limited to plant oils such as pine oil; C5-C7 alkanols such as methyl isobutyl carbinol, cyclohexanol, and the like; glycols such as polypropylene glycol, polyethylene glycol, copolymers of these, and alkoxy substituted adducts thereof, alkoxy substituted hydrocarbons such as triethoxybutane and other ethoxylated and propoxylated hydrocarbons; and any mixture of these. Where a frothing agent is added to a lithium beneficiation slurry, it is added in an amount between 10 g/t and 10,000 g/t, such as 10 g/t to 100 g/t, 100 g/t to 200 g/t, 200 g/t to 300 g/t, 300 g/t to 400 g/t, 400 g/t to 500 g/t, 500 g/t to 600 g/t, 600 g/t to 700 g/t, 700 g/t to 800 g/t, 800 g/t to 900 g/t, 900 g/t to 1000 g/t, 1000 g/t to 2000 g/t, 2000 g/t to 3000 g/t, 3000 g/t to 4000 g/t, 4000 g/t to 5000 g/t, 5000 g/t to 6000 g/t, 6000 g/t to 7000 g/t, 7000 g/t to 8000 g/t, 8000 g/t to 9000 g/t, or 9000 g/t to 10,000 g/t of frothing agent.

In any one or more third embodiments herein, the collector components and optional frothing agent may be added in two or more portions to a lithium ore source or a lithium ore slurry, whether as a mixture thereof or as separate components thereof, in any order, to form a lithium beneficiation slurry.

In any one or more third embodiments herein, the pH of a lithium beneficiation slurry is, or is adjusted to be, 7.0 or more. Accordingly, in any one or more third embodiments herein, a lithium beneficiation slurry includes one or more pH adjustment agents. The one or more pH adjustment agents may be suitably added to a water source before or after the water source is contacted with the lithium ore source. Further, a pH adjustment agent is suitably added to a water source before and/or after the water source is contacted with any other component of the lithium beneficiation slurry. In embodiments, a lithium beneficiation slurry has a pH of about 7.0 to about 11.5, for example 7.0-7.5, 7.5-8.0, 8.0-8.5, 8.5-9.0, 9.0-9.5, 9.5-10, 10.0-10.5, 10.5-11.0, 11.0-11.5, 7.5-10.0, 7.5-9.0, 7.5-8.5, 7.0-10.0, 7.0-9.0, 7.0-8.5, or 7.0-8.0. Suitable pH adjustment agents include NaOH (caustic, or lye), KOH, sodium carbonate (soda ash), or another strong base, wherein the pH adjustment agent is added to a water source before or after contact of the water source with a lithium ore source or the conditioning slurry to obtain pH thereof that is between about 7.0 and about 11.5; or the pH adjustment agent is added directly to a lithium beneficiation slurry to obtain pH thereof that is between about 7.0 and about 11.5. In some embodiments, the pH adjustment agent is added as an aqueous solution thereof, for example a 0.1 wt % to 50 wt % solution in water, for ease of addition and incorporation.

### Fourth Embodiments

In fourth embodiments herein, methods or processes of lithium ore beneficiation are disclosed. In any one or more fourth embodiments herein, the beneficiation methods comprise, consist essentially of, or consist of sparging a lithium beneficiation slurry of third embodiments herein, to form a sparged lithium beneficiation slurry; allowing the sparged lithium beneficiation slurry to separate, forming a lithium beneficiary and a gangue; and collecting a lithium beneficiary from the gangue. As used in fourth embodiments herein, “collecting” means physically and permanently removing a beneficiary from a gangue. Accordingly, in any one or more fourth embodiments herein, the lithium ore beneficiation methods comprise, consist essentially of, or consist of combining a lithium ore source, a water source, and a collector composition of second embodiments herein, to form a lithium beneficiation slurry in accordance with third embodiments herein; and sparging and/or agitating the lithium beneficiation slurry; and collecting a lithium beneficiary therefrom.

In some fourth embodiments herein, a lithium ore source is conditioned by combining the lithium ore source with the collector composition to form a conditioning slurry; allowing a conditioning period of time to pass, such as about 1 minute to about 12 hours, for example 1 minute to 10 minutes, 10 minutes to 30 minutes, 30 minutes to 1 hour, 1-2 hours, 2-3 hours, 3-4 hours, 4-5 hours, 5-6 hours, 6-7 hours, 7-8 hours, 8-9 hours, 9-10 hours, 10-11 hours, or even 11-12 hours. The conditioning period of time is followed by adding the water source to the conditioning slurry to form a lithium beneficiation slurry. In some such embodiments, the conditioning further includes agitation of the conditioning slurry during the period of time.

Any one or more methods of fourth embodiments herein suitably exclude adding a frothing agent to the lithium ore source, and/or to the water source, and/or to the collector composition, and/or to the lithium ore slurry, and/or to the lithium beneficiation slurry, and/or to the conditioning slurry (where one is formed). Accordingly, any one or more methods of fourth embodiments excludes adding a frothing agent at any point in the conditioning or flotation process.

In any one or more beneficiation methods of fourth embodiments herein, the method further includes adjusting the pH of the water source, the lithium ore slurry, or the lithium beneficiation slurry to be between 7.0 and 11.5 by adding a pH adjustment agent thereto. In some methods of fourth embodiments, the pH adjustment agent is sodium hydroxide, potassium hydroxide, carbon dioxide, or sodium carbonate. Accordingly, in some fourth embodiments, the method of lithium beneficiation further includes adding one or more pH adjustment agents to a water source, and/or to a lithium ore slurry, and/or to a lithium beneficiation slurry prior to the sparging. In some embodiments, the pH adjustment agent is added as an aqueous solution thereof, for example a 0.1 wt % to 50 wt % solution in water, for ease of addition and incorporation.

For example, the one or more pH adjustment agents may be suitably added to a water source before or after the water source is contacted with the lithium ore source. Further, a pH adjustment agent is suitably added to a water source before and/or after the water source is contacted with another component of the lithium beneficiation slurry. In some methods of fourth embodiments herein, a pH adjustment agent is added to a water source before contact of the water source with a lithium ore source or with a conditioning slurry. In some such embodiments, the combining of the pH adjusted water source with the lithium ore source obtains a lithium ore slurry having a pH that is between about 7.0 and about 11.5. In other such embodiments, the combining of the pH adjusted water source with a conditioning slurry obtains a lithium beneficiation slurry having a pH that is between about 7.0 and about 11.5. In still other such embodiments, the combining of the pH adjusted water source with a lithium beneficiation slurry obtains a lithium beneficiation slurry having a pH that is between about 7.0 and about 11.5.

In some methods of fourth embodiments herein, the lithium ore beneficiation is carried out in a lab scale flotation cell. In other methods of fourth embodiments herein, the lithium ore beneficiation is carried out in a froth flotation circuit. In any one or more fourth embodiments herein, the method of lithium ore beneficiation is “direct flotation”, which includes collecting an overflow, or froth, that is enriched in the lithium mineral product (beneficiary), collecting an underflow (gangue) that is depleted in the lithium mineral product, or collecting both an overflow and an underflow, wherein the collecting comprises, consists essentially of, or consists of physically removing at least a portion of an overflow from contact with at least a portion of an underflow arising from sparging a lithium beneficiation slurry of any of third embodiments herein, such that the removal from contact, or “collecting” is or can be permanent if desired. In any one or more methods of fourth embodiments herein, collecting an overflow or beneficiary comprises, consists of, or consists essentially of: tapping off at least a portion of the overflow, skimming off at least a portion of the overflow, depositing at least a portion of the overflow onto a launder, decanting at least a portion of the overflow, or any combination thereof.

In some alternative methods of fourth embodiments herein, the lithium ore beneficiation is “reverse flotation”, wherein the overflow is enriched in gangue materials, and the underflow is enriched in the lithium mineral product.

In accordance with the methods of fourth embodiments, the lithium beneficiary collected after one beneficiation (flotation) cycle or step obtains a reduction of at least 10% in the total organic carbon (TOC) by weight, compared to the TOC of the lithium ore source. In any one or more methods of fourth embodiments herein, the TOC of a lithium ore source or a lithium beneficiary is suitably determined using the procedure of Schumacher, B., “Methods for the Determination of Total Organic Carbon (TOC) in Soils and Sediments” (Doc. No. NCEA-C-1282) published April 2002 by the Ecological Risk Assessment Support Center Office of Research and Development, U.S. Environmental Protection Agency; and available at https://www.epa.gov/nscep.

In some methods of fourth embodiments, the fatty acid source is a Mixture (A) or Mixture (B) of fatty acids. In such methods, the lithium beneficiary obtained includes at least a 10% reduction in TOC by weight compared to the amount of TOC obtained in a lithium beneficiary by carrying out the same method but using a collector composition that does not include a fatty acid source that is a Mixture (A) or Mixture (B) of fatty acids. Accordingly, in any one or more methods of fourth embodiments herein where the fatty acid source is a Mixture (A) or Mixture (B) of fatty acids, the lithium beneficiary obtained includes 10%-70% lower TOC by weight compared to the amount of TOC obtained in a lithium beneficiary by carrying out the same method but using a collector composition that does not include a fatty acid source that is a Mixture (A) or Mixture (B) of fatty acids, for example 10%-15% lower, 15-20% lower, 20%-25% lower, 25%-30% lower, 30%-35% lower, 35%-40% lower, 40%-45% lower, 45%-50% lower, or 50%-55% lower, 55%-60% lower, 60%-65% lower, 65%-70% lower, about 10% lower, about 15% lower, about 10% lower, about 15% lower, about 20% lower, about 25% lower, about 30% lower, about 35% lower, about 40% lower, about 45% lower, about 50% lower, about 55% lower, about 60% lower, about 65% lower, or about 70% lower TOC by weight compared to the amount of TOC obtained in a lithium beneficiary by carrying out the same method but using a collector composition that does not include a fatty acid source that is a Mixture (A) or Mixture (B) of fatty acids.

In the methods of fourth embodiments, the lithium beneficiary collected after one beneficiation (flotation) cycle or step obtains an increased amount of the desired lithium mineral product compared to the amount of the lithium mineral product present in the lithium ore source, calculated as Li₂O. In any one or more methods of fourth embodiments herein, the amount of lithium as Li₂O in an ore source or in a lithium beneficiary is determined by inductively coupled plasma techniques, or alternatively using one or more of the methods of lithium analysis set forth in V. Balaram, et al., “Lithium: A review of applications, occurrence, exploration, extraction, recycling, analysis, and environmental impact”, Geoscience Frontiers, Volume 15, Issue 5, September 2024, 101868.

In some methods of fourth embodiments, a lithium beneficiary collected after one beneficiation (flotation) cycle or step obtains at least 3% more Li₂O by weight than the lithium ore source.

In some methods of fourth embodiments, the fatty acid source is a Mixture (A) or Mixture (B) of fatty acids. In such methods, the lithium beneficiary obtained includes at least 3% more Li₂O by weight than the lithium beneficiary obtained by carrying out the same method but using a collector composition that does not include a fatty acid source that is a Mixture (A) or Mixture (B) of fatty acids. Accordingly, in any one or more methods of fourth embodiments herein where the fatty acid source is a Mixture (A) or Mixture (B) of fatty acids, the lithium beneficiary obtained includes 3% to 15% more Li₂O by weight compared to the amount of Li₂O obtained in a lithium beneficiary by carrying out the same method but using a collector composition that does not include a fatty acid source that is a Mixture (A) or Mixture (B) of fatty acids, for example 3%-4% more, 4%-5% more, 5%-6% more, 6%-7% more, 7%-8% more, 8%-9% more, 9%-10% more, 10%-11% more, 11%-12% more, 12%-13% more, 13%-14% more, 14%-15% more, about 3% more, about 4% more, about 5% more about 6% more, about 7% more, about 8% more, about 9% more, about 10% more, about 11% more, about 12% more, about 13% more, bout 14% more, or about 15% more Li₂O by weight compared to the amount of Li₂O obtained in a lithium beneficiary by carrying out the same method but using a collector composition that does not include a fatty acid source that is a Mixture (A) or Mixture (B) of fatty acids.

In the methods of fourth embodiments, the lithium beneficiary collected after one beneficiation (flotation) cycle or step obtains a reduction of at least 10% in the amount of iron (Fe) by weight, compared to the weight of Fe in the lithium ore source. In any one or more methods of fourth embodiments herein, the amount of Fe in an ore source or in a lithium beneficiary is determined as Fe₂O₃, by inductively coupled plasma techniques. In some methods of fourth embodiments, the fatty acid source is a Mixture (A) or Mixture (B) of fatty acids. In such methods, the lithium beneficiary obtained includes at least a 10% reduction in Fe by weight compared to the amount of Fe obtained in a lithium beneficiary by carrying out the same method but using a collector composition that does not include a fatty acid source that is a Mixture (A) or Mixture (B) of fatty acids. Accordingly, in any one or more methods of fourth embodiments herein where the fatty acid source is a Mixture (A) or Mixture (B) of fatty acids, the lithium beneficiary obtained includes 10%-25% lower Fe by weight compared to the amount of Fe obtained in a lithium beneficiary by carrying out the same method but using a collector composition that does not include a fatty acid source that is a Mixture (A) or Mixture (B) of fatty acids, for example 10%-15% lower, 15-20% lower, 20%-25% lower, about 10% lower, about 15% lower, about 20% lower, or even about 25% lower than the Fe obtained in a lithium beneficiary by carrying out the same method but using a collector composition that does not include a fatty acid source that is a Mixture (A) or Mixture (B) of fatty acids.

### Fifth Embodiments

Disclosed in fifth embodiments herein is the use of any one of the Fatty Mixtures of first embodiments, collector compositions of second embodiments, and lithium beneficiation slurries of third embodiments herein. Accordingly, in any one or more fifth embodiments herein, a Fatty Mixture of any of first embodiments is used to form a collector composition of second embodiments when at least a solvent and a surfactant are added thereto. Also disclosed in fifth embodiments herein is the use of any one of the collector compositions of second embodiments herein to form a lithium beneficiation slurry in accordance with any of third embodiments herein, when the collector compositions are combined with a lithium ore source or a lithium ore slurry.

Also disclosed in fifth embodiments herein is the use of any one of the collector compositions of second embodiments to obtain beneficiation of a lithium ore by froth flotation. In some such embodiments, the collector composition comprises actives comprising, consisting essentially of, or consisting any one of the Fatty Mixtures of first embodiments herein; and the collector composition is used in an amount of between 1 g and 10,000 g actives per metric ton of the lithium ore present in a lithium beneficiation slurry to obtain effective separation of a lithium includes collecting an overflow enriched in the lithium mineral product (beneficiary), collecting an underflow (gangue), or collecting both an overflow and an underflow.

In some fifth embodiments herein, a kit comprising, consisting essentially of, or consisting of a Fatty Mixture of first embodiments enclosed in a container; or a collector composition of second embodiments enclosed in a container are useful for beneficiation of lithium ore sources. A collector composition kit is used by opening the container and applying the contents enclosed therein to a lithium ore source to form a conditioning slurry; or to a lithium ore slurry to form a lithium beneficiation slurry. A Fatty Mixture kit is used by opening the container and: a. adding a solvent and a surfactant to the container, then adding the contents of the container to a lithium ore source or a lithium ore slurry; or b. dispensing the contents of the container into a vessel or a mixer (either a static or dynamic mixer) where a solvent and a surfactant are combined with the contents of the container and mixed therewith; and the mixed contents of the vessel or mixer are added to a lithium ore source or to a lithium ore slurry; or c. dispensing the contents of the container directly onto a lithium ore source or into a lithium ore slurry.

In some fifth embodiments, a Fatty Mixture kit is a dual container kit comprising, consisting essentially of, or consisting of a first container enclosing a Fatty Mixture of first embodiments; and a second container enclosing an admixture of a surfactant as described in second embodiments herein, and a solvent as described in second embodiments herein. In such embodiments, the dual container kit is used by opening both containers and combining their contents to form a collector composition of second embodiments herein, then adding the combined contents of the first and second containers to a lithium ore source to form a conditioning slurry; or adding the combined contents of the first and second containers to a lithium ore slurry to form a lithium beneficiation slurry. In some such embodiments, the dual container kit is used by combining the entire contents of the first container with the entire contents of the second container to obtain a collector composition of second embodiments herein. In other such embodiments, specific ratios of the contents of the first and second containers are combined in order to obtain a collector composition or a conditioning slurry. In some such embodiments, the dual container kit further includes instructions for combining specific ratios of the contents of the first and second containers in order to obtain a collector composition and/or a conditioning slurry.

Additionally, in any one or more fifth embodiments herein, the Fatty Mixtures of first embodiments are used to obtain lithium beneficiaries having reduced total organic carbon (TOC) content, and/or reduced iron (Fe) content, and/or increased lithium (Li₂O) content. As noted in third embodiments above, the Fatty Mixture components are the “actives” of the collector compositions—that is, the components of the collector composition that are effective to obtain the unexpectedly superior results observed by carrying out the methods of fourth embodiments: reduced TOC, reduced Fe, and increased Li₂O content in the lithium beneficiaries collected.

### EXPERIMENTAL SECTION

A series of collector compositions were formed by admixing the components shown in Table 3.

TABLE 3
Components and amounts, in percent by weight, of Collector
Compositions (CC) 1-4 and a Collector Composition Control
(CCC).

| Component of Collector | Wt % component | | | | |
|---|---|---|---|---|---|
| Composition (CC) | CCC | CC1 | CC2 | CC3 | CC4 |
| Fatty acids C1 C20: 60% to 98% | 100 | 26 | | | 63 |
| C18; 1 to 9% C16; 0 to 5% C14, | | | | | |
| 0 to 5% C12 by weight | | | | | |
| Fatty acids C12-C20: 70% to | | | 88 | 63 | |
| 98% of C18; 9 to 20% of C16; | | | | | |
| 0 to 5% of C14, 0 to 5% of C12 | | | | | |
| by weight | | | | | |
| Sulfonated fatty acid, C18 | | | | 13 | |
| (100% C18 by weight) | | | | | |
| Sulfonated fatty acid C12-C20: | | | | | 13 |
| 60% to 98% C18; 1 to 9% C16; | | | | | |
| 0 to 5% C14, 0 to 5% C12 by | | | | | |
| weight | | | | | |
| Fatty acid salt (sodium/ | 0 | 31 | 0 | 3 | 3 |
| potassium), C12-C20 | | | | | |
| Fatty adduct of succinic | | 4 | 4 | 4 | 4 |
| anhydride, C12-C50 | | | | | |
| Mixture of alkoxylated sorbitan | | 3 | 3 | 3 | 3 |
| esters, C12-C50 | | | | | |
| C1 to C4 glycol-based solvent | | 5 | 5 | 5 | 5 |
| Water | | 31 | | 9 | 9 |

Froth flotation of a lithium ore was carried out using the following general procedure. First, 2 kg of a comminuted spodumene ore is added to a 3-liter batch flotation cell. Water is added to the flotation cell until the total volume of the cell contents reaches 2.5 liters. A collector is added to the cell in an amount to obtain 500 g of actives (collector components aside from water, any solvent(s), and any surfactant(s)) per ton of the lithium ore. Then 0.73 g of soda ash is added to the cell, and the temperature and pH of the cell contents is determined. Then the cell is closed and agitated with an impeller at 650 rpm for 10 minutes; then agitation is stopped and the cell volume is readjusted to 3 liters. If a frothing agent is to be added, it is added at this stage in the desired amount. Then the cell contents are sparged with air at 3-4 liters/min while agitating the cell contents at 550 rpm with the impeller.

After a 90 second period of sparging/agitation, both the sparging and the agitation are stopped for 30 seconds, and any froth (foam) on the surface of the cell contents is scraped off and set aside for analysis. The sparging/agitation followed by 30 seconds of beneficiary collection is repeated two more times. After each collection, the volume of the cell contents is readjusted to 3 liters, and the pH measured prior to restarting sparging/agitation. After the third beneficiary collection, sparging/agitation is resumed again, but at 630 rpm; and the sparge rate is set to 8-10 liters/min. The sparging and agitation are continued for 90 seconds, then the air flow and impeller are turned off and all visible froth is collected from the surface of the cell contents.

The collected froth aliquots are filtered and dried, and the remaining cell contents (tailings, or gangue) are separately collected and dried. The percentage of mass recovered from the dried froth vs. the dried tailings, and total organic carbon (TOC), lithium content (as Li₂O), and iron content (as Fe₂O₃) of both the froth and tailings are determined.

TOC is determined using the procedure set forth by Schumacher, B., “Methods for the Determination of Total Organic Carbon (TOC) in Soils and Sediments” (Doc. No. NCEA-C-1282) published April 2002 by the Ecological Risk Assessment Support Center Office of Research and Development, U.S. Environmental Protection Agency; and available at https://www.epa.gov/nscep. Li₂O and Fe₂O₃ are determined using inductively coupled plasma optical emission spectrometry (ICP-OES), as set forth in “Elemental Analysis of Solution Samples with Inductively Coupled Plasma Optical Emission Spectrometry”, published by the Soil and Plant Analysis Laboratory, University of Wisconsin—Madison October 2005/rev. December 2005 (see http://uwlab.soils.wisc.edu).

### Example 1

The foregoing froth flotation procedure was carried out using the collector compositions CCC and CC1-CC4 to obtain separation of a spodumene ore. No frothing agents were added during the flotations. The collected phases (froth, or beneficiary; and tailings, or gangue) were analyzed as shown in Table 4.

TABLE 4
Results obtained from froth flotation of spodumene
ore using the collector compositions of Table 3.

| | | % of | | | |
|---|---|---|---|---|---|
| | | total | | | |
| Collector | Collected | dry | % | % | % |
| composition | phase | mass | Li₂O | Fe₂O₃ | TOC |
| CCC | Froth | 23.8 | 4.67 | 3.3 | 0.16 |
| (control) | Tailings | 76.2 | 0.69 | | |
| CC1 | Froth | 35.5 | 3.16 | 2.4 | 0.15 |
| | Tailings | 64.5 | 0.82 | | |
| CC2 | Froth | 26.2 | 4.42 | 3.3 | 0.12 |
| | Tailings | 73.8 | 0.66 | | |
| CC3 | Froth | 31.6 | 4.02 | 2.6 | 0.07 |
| | Tailings | 68.4 | 0.37 | | |
| CC4 | Froth | 21.3 | 4.56 | 3.6 | 0.08 |
| | Tailings | 78.7 | 0.86 | | |

It can be seen in the results set forth in Table 4 that each of the lithium beneficiaries obtained by flotation using CC1-CC4 had improved reduction in TOC over the beneficiary obtained using TOFA alone (CCC); CC3 and CC4 obtained a 50% or greater improvement in TOC reduction compared to CCC. Table 4 also shows that the lithium beneficiary obtained by flotation using CC1 and CC3 had improved reduction in Fe compared to over the beneficiary obtained using CCC.

### Example 2

The procedure of Example 1 was repeated using the collectors and frothing agents shown in Table 5. Results of the froth flotation are also shown in Table 5.

TABLE 5
Additional results obtained from froth flotation of spodumene
ore using the collector compositions of Table 3.

| | | | % of | | | |
|---|---|---|---|---|---|---|
| | | | total | | | |
| Collector | | Collected | dry | % | % | % |
| composition | Frothing agent | phase | mass | Li₂O | Fe₂O₃ | TOC |
| CCC | Polypropylene glycol, | Froth | 23.0 | 4.98 | 0.94 | 0.21 |
| (control) | 4 g/t based on weight | Tailings | 77.0 | 0.22 | 0.09 | |
| | of spodumene ore | | | | | |
| CCC | none | Froth | 18.6 | 5.50 | 1.04 | 0.21 |
| (control) | | Tailings | 81.4 | 0.40 | 0.11 | |
| CC2 | none | Froth | 33.9 | 3.48 | 0.71 | 0.18 |
| | | Tailings | 66.1 | 0.24 | 0.08 | |
| CC3 | none | Froth | 29.7 | 4.20 | 0.81 | 0.17 |
| | | Tailings | 70.3 | 0.17 | 0.07 | |

The data presented in Table 5 indicates that the lithium concentrates obtained through flotation using CC2 and CC3 exhibited a superior reduction in Total Organic Carbon (TOC) compared to those obtained using TOFA alone (CCC) or TOFA with an additional frothing agent. Notably, no frothing agents were employed in the tests involving CC2 and CC3. The use of CC2 and CC3 resulted in a TOC reduction improvement of 14% or more relative to CCC, regardless of whether a frothing agent was used in conjunction with CCC. Furthermore, Table 5 demonstrates that the lithium concentrates obtained via flotation with CC2 and CC3 obtained improved reduction in iron (Fe) content compared to reduction in Fe obtained using CCC.

What is claimed is:

1. A collector composition comprising:
a fatty mixture comprising
a fatty acid source,
a sulfonated fatty acid source, and
a fatty adduct of succinic anhydride;
a solvent; and
optionally, a surfactant.

2. The collector composition of claim 1 wherein the solvent comprises an alkanol having 1 to 6 carbons, a glycol having 1 to 4 carbons, or a combination of two or more thereof, or wherein the solvent is present in the collector composition in an amount of 0.1 parts by weight to 30 parts by weight.

3. The collector composition of claim 1, wherein the collector composition comprises about 0.1 parts by weight to 20 parts by weight of the surfactant.

4. The collector composition of claim 1 wherein the surfactant is a nonionic surfactant having an HLB between 2 and 20, or wherein the surfactant is an ethoxylated sorbitan fatty acid ester, or wherein the surfactant comprises an ethoxylated sorbitan oleic acid ester.

5. The collector composition of claim 1 wherein the composition comprises:
about 50 parts to about 80 parts by weight of the fatty acid source,
about 1 part to about 45 parts by weight of the sulfonated tall oil fatty acid source,
about 0.1 parts to about 20 parts by weight of the fatty adduct of succinic anhydride, and
about 0.1 parts to about 30 parts by weight of the solvent.

6. The collector composition of claim 1 wherein the sulfonated fatty acid source comprises a sulfonated fatty acid, a conjugate base thereof, or a combination thereof, optionally wherein the conjugate base comprises a sodium salt.

7. The collector composition of claim 1 wherein the fatty adduct of succinic anhydride has a structure according to formula I, 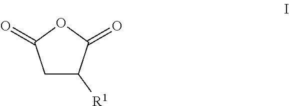
wherein R₁ is a C12-C50 linear or branched alkyl or alkenyl group, or wherein R¹ is octadecenyl, hexadecenyl, or a combination thereof.

8. The collector composition of claim 1 wherein the ratio of the fatty acid source to the sulfonated fatty acid source in the fatty mixture is about 20:1 to about 1:1 by weight, or about 5:1 to about 3:1 by weight.

9. The collector composition of claim 1 wherein the ratio of the fatty acid source to the fatty adduct of succinic anhydride in the fatty mixture is about 50:1 to about 5:1 by weight, or about 20:1 to about 10:1 by weight.

10. The collector composition of claim 1 wherein the ratio of the sulfonated fatty acid source to the fatty adduct of succinic anhydride in the fatty mixture is about 10:1 to about 1:1 by weight, or about 5:1 to about 3:1 by weight.

11. A method of froth flotation comprising steps (I) or steps (II):
(I) combining a lithium ore source and a water source to form a lithium ore slurry;
applying a collector composition to the lithium ore slurry to form a lithium beneficiation slurry, the collector composition comprising
a solvent,
optionally a surfactant, and
a fatty mixture comprising a fatty acid source, a sulfonated tall oil fatty acid source, and a fatty adduct of succinic anhydride;
sparging the lithium beneficiation slurry; and
collecting a lithium beneficiary from the sparged lithium beneficiation slurry;
(II) applying a collector composition to a lithium ore source to form a conditioning slurry;
combining a water source with the conditioning slurry to form a lithium beneficiation slurry;
sparging the lithium beneficiation slurry; and
collecting a lithium beneficiary from the sparged lithium beneficiation slurry,
wherein steps (I) and/or steps (II) optionally further include adding a pH adjustment agent to the lithium ore slurry, and/or to the lithium beneficiation slurry, and/or to the conditioning slurry in an amount sufficient to obtain a pH of 7.0-11.5.

12. The method of claim 11, wherein the method further comprises adding a frothing agent to the lithium ore slurry, and/or to the lithium beneficiation slurry, and/or to the conditioning slurry.

13. The method of claim 11, wherein the method excludes adding a frothing agent.

14. The method of claim 12 wherein the applying the collector composition comprises adding 400 to 800 grams of the fatty mixture per ton of the lithium ore source.

15. The method of claim 12 wherein the lithium beneficiary obtains at least 3% more Li₂O by weight than the lithium ore source, or wherein the lithium beneficiary obtains at least 10% less TOC by weight than the lithium ore source, or wherein the lithium beneficiary obtains at least 10% less Fe by weight than the lithium ore source.

16. The method of claim 11 wherein the sulfonated fatty acid source comprises a sulfonated fatty acid, a conjugate base thereof, or a combination thereof, optionally wherein the conjugate base comprises a sodium salt.

17. The method of claim 11 wherein the fatty adduct of succinic anhydride has a structure according to formula I, 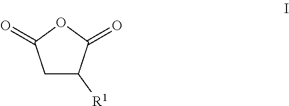
wherein R¹ is a C12-C50 linear or branched alkyl or alkenyl group, or wherein R¹ is octadecenyl, hexadecenyl, or a combination thereof.

18. The method of claim 11 wherein the ratio of the fatty acid source to the sulfonated fatty acid source in the fatty mixture is about 20:1 to about 1:1 by weight, or about 5:1 to about 3:1 by weight.

19. The method of claim 11 wherein the ratio of the fatty acid source to the fatty adduct of succinic anhydride in the fatty mixture is about 50:1 to about 5:1 by weight, or about 20:1 to about 10:1 by weight.

20. The method of claim 11 wherein the ratio of the fatty acid source to the sulfonated fatty acid source to the fatty adduct of succinic anhydride in the fatty mixture is about 15:4:1 by weight.
